(19) United States
(12) Patent Application Publication
(10) Pub. No.: US 2003/0226801 A1
(43) Pub. Date: Dec. 11, 2003

(54) Slotted screen assembly

(75) Inventors: Hubert Gassmann, Regenstauf (DE); Thomas Mickelat, Nittenau (DE)

Correspondence Address: HENRY M FEIEREISEN, LLC, 350 FIFTH AVENUE, SUITE 4714, NEW YORK, NY, 10118, US

(73) Assignee: HEINRICH FIEDLER GMBH & CO. KG, Regensburg (DE)

(21) Appl. No.: 10/421,637

(22) Filed: Apr. 23, 2003

Related U.S. Application Data
(63) Continuation of application No. PCT/EP01/12304, filed on Oct. 24, 2001.

(30) Foreign Application Priority Data
Oct. 24, 2000 (DE) 100 52 715.9

(51) Int. Cl. B01D 35/28

(52) U.S. Cl. 210/499

(57) ABSTRACT

A slotted screen assembly, in particular for treatment of fiber suspensions in the paper industry, includes at least one reinforcement element, and a plurality of rods extending in predetermined spaced-apart parallel relationship and fixed to the at least one reinforcement element. A spacer element is provided for adjusting a distance between neighboring rods upon the reinforcement element to thereby define a gap width of the slotted screen assembly, thereby maintaining a relative position between the rods at a distance which is variable. The rods and/or the spacer element form a form-fitting connection with the reinforcement, element.

### CROSS-REFERENCES TO RELATED APPLICATIONS

This application is a continuation of prior filed copending PCT International application no. PCT/EP01/12304, filed Oct. 24, 2001, on which priority is claimed under 35 U.S.C. §120, the disclosure of which is hereby incorporated by reference.

This application claims the priority of German Patent Application, Serial No. 100 52 715.9, filed Oct. 24, 2000, pursuant to 35 U.S.C. 119(a)-(d), the disclosure of which is incorporated herein by reference.

### BACKGROUND OF THE INVENTION

The present invention relates to a slotted screen assembly which is intended in particular for treatment of fiber suspensions in the paper industry.

Typical slotted screen assemblies are oftentimes realized in the form of preferably cylindrical slotted screen baskets.

WO 97/34045 or U.S. Pat. No. 5,954,956 disclose a slotted screen basket having a plurality of wire-like profiled rods (in the following generally designated as rods) disposed in predetermined spaced-apart parallel relationship and fixed to at least one reinforcement element, configured in this example as reinforcement ring, whereby the spaced-apart relationship of the profiled rods is determinative for the gap width of the slotted screen assembly. The rod assumes hereby the function of partition and determination of the gap width between neighboring rods. The rods are positioned in form-fitting manner in recesses of the reinforcement rings and braced by means of axial tie bars. The rods are provided with grooves incorporated in longitudinal direction for forming surfaces, which project out in circumferential direction at least at the ends and rest against corresponding circumferentially projecting surfaces of the respectively neighboring rod, when the slotted screen assembly is assembled, to thereby determine the gap width of the slotted screen assembly.

The grooves provided in the reinforcement ring for form-fitting reception of the rods and the bores for the guidance of the tie rods weaken, as a consequence of the notch effect, the strength of the reinforcement element whose main function in a slotted screen basket, when configured in a ring-shaped manner, resides in the absorption of radial stress. A weakening in strength as a result of the grooves must be taken into account, when conceiving the reinforcement element, and leads oftentimes to a selection of reinforcement elements with respectively greater dimensions. As a consequence, not only is the material consumption increased for the production but also the available gap width effective for treatment of the fiber suspension may hereby be shortened. Thus, the efficiency of such a slotted screen assembly is adversely affected.

U.S. Pat. No. 4,846,971 discloses the manufacture of a slotted screen cylinder without a welded connection between rods and a reinforcement element. The rod and the reinforcement element are provided with groove-shaped recesses which provide the form-fitting connection through clamping, when arranged in interlocking disposition.

International patent publication no. WO 98/14658 describes a screen apparatus in which the rods (profile wires) are connected with the reinforcement elements in the form of reinforcement rings in such a manner that the foot portion of the rods is deformed.

European Pat. No. EP 0 417 408 B1 discloses a screen apparatus having rods and reinforcement rings, whereby both these parts are connected by means of a combination of forced engagement and form-fitting joint.

Alternative embodiments for making screen apparatuses of the slotted screen type, as also described in International patent publication no. WO 97/34045, involve a material union of the rods and the reinforcement elements, e.g. through soldering, welding or welding-based joining process by means of electron-beam. These material unions realized under heat exposure result, on one hand, in internal stress in the joined parts and, on the other hand, the heat exposure can also lead to warping of the components, so that the provision of a uniform gap width substantially along the entire axial dimension of the rods cannot be ensured. Internal stress possibly cause by the material union result also in strength problems in conjunction with the configuration of slotted screen assemblies.

It would therefore be desirable and advantageous to provide an improved slotted screen assembly which substantially obviates the afore-stated difficulties and permits a flexible, cost-efficient manufacture with good productivity of the manufactured slotted screen assemblies.

### SUMMARY OF THE INVENTION

According to one aspect of the present invention, a slotted screen assembly, in particular for treatment of fiber suspensions in the paper industry, includes a plurality of rods extending in predetermined spaced-apart parallel relationship and fixed to at least one reinforcement element, whereby the mutual distance of the rods determines the gap width of the slotted screen assembly, and a spacer element for adjusting the respectively predeterminable gap width, wherein the spacer element maintains the rods upon the reinforcement element in predetermined, but variable distance, and wherein by providing the rods and/or the spacer element are form-fittingly connect with the reinforcement element.

The present invention resolves prior art problems by providing a slotted screen assembly, which adjusts the respective gap width in accordance with the application at hand, by providing spacer element which maintains the rods upon the reinforcement element at the desired distance in circumferential direction. As a consequence, slotted screen assemblies can be realized like a modular system to suit the demands requested by the customer, whereby stocked semi-finished products are used to provide a flexible variety of slotted screen assemblies to individually suit the application. A cost-efficient production can be implemented despite a number of possible variations of slotted screen assemblies. The individual parts of the slotted screen assembly can be pre-fabricated in large quantities so that the individual production costs can be significantly reduced. The absence of a material union of the components in the configuration of the slotted screen assembly according to the invention constructively eliminates problems arising as a result of heat exposure in a simple manner. Still, a uniform gap width can be established and maintained. Further, the rods and/or the spacer element forms with the reinforcement element a form-fitting connection, thereby realizing a simplified assembly of the slotted screen assembly and in particular effectively preventing a weakening in strength of the reinforcement element.

According to a preferred embodiment of the connection of spacer element, rod and reinforcement element, the spacer element assumes a kind of locking function and implements the clamping and form-fitting connection of rod and reinforcement element during assembly.

There are several ways to respectively adjust the predeterminable, variable gap width. According to a first preferred embodiment, the respectively predeterminable, variable gap width is governed by the thickness of the spacer element. In such an embodiment, spacer elements of different thickness are thus used in dependence on the respectively desired gap width. Apart from a cost-efficient manufacture, the spacer element, which can be precisely produced as individual part, of such an embodiment ensures that the rods uniformly maintain the mutual respective desired predetermined distance so that a uniform gap width can be realized in the slotted screen assembly according to the invention.

As an alternative, the respectively predetermined gap width can be established by the interaction of foot width of the rods and the spacer element. In such an embodiment, the foot width of the rods is thus not constant, unlike the previously described embodiment, but the different gap widths can be implemented by different, standardized foot widths of the rods. The thickness of the spacer elements can hereby be kept constant so that the spacer elements can be mass-produced and errors as a result of mix-up can be precluded during assembly, when, for example, spacer elements of different thickness must be used during assembly of varying slotted screen assemblies. Thus, the risk of assembly errors can be reduced in such an embodiment. Also, the assembly can then optionally be automated in a simple manner.

According to a preferred embodiment, the spacer element can be formed upon the rods, for example, through stamping and/or perforating. In this way, the manufacture can be possibly even further simplified.

In another configuration of the slotted screen assembly according to the invention, a spacer element is arranged as separate component between the rods and connected in form-fitting manner with the reinforcement element. This preferred configuration enables a cost-efficient manufacture of the spacer elements even in large numbers at manufacturing tolerances which are as precise as possible, and the form-fitting connection with the reinforcement element allows a plug-in joining of the components of the slotted screen assembly, without the need for additional processing steps, in order to realize an even further simplified manufacture. In addition, a greater free open surface can be attained in axial direction of the slotted screen assembly, thereby enhancing the efficiency of such a slotted screen assembly.

Preferably, for provision of a form-fitting connection, the spacer element or the reinforcement element is provided with a groove and the respectively other component is provided with a complementary projection. To prevent weakening of the reinforcement element, which has to absorb fairly great radial loads, when configured as a ring in a slotted screen basket, preferably the spacer element is provided with the groove and the reinforcement element with the complementary projection. Thus, possible notch effects on the grooves are prevented from adversely affecting the strength of the reinforcement element.

Preferably, the groove has a base at a width which is greater than the width at the opening region. The form-fitting connection additionally establishes a wedge effect which further supports a firm union of spacer element and reinforcement element.

In order to make the hydraulic resistance in the operating state of the slotted screen assembly as small as possible and to prevent fibers to adhere during operation, the spacer element has an outer flow-confronting contour of a shape which enhances the flow dynamics, for example is respectively rounded.

Further, the spacer element has areas which face the reinforcement element and conforms without transition to the contour of the reinforcement element.

In particular, the spacer element is substantially configured in the shape of a triangle and the tip area of the triangle points preferably in the direction of the rod. The groove for form-fitting connection with the reinforcement element is then formed on one triangle side.

In order to reliable adjust the desired gap width by means of the spacer element, the spacer element is grinded to the desired thickness. The thickness of the spacer elements can vary from slotted screen assembly to slotted screen assembly so that flexibility is hereby realized in order to match and suit respectively desired demands.

In a further configuration according to the invention, the rods and the respective spacer element may have a corresponding perforation, and a wire-like fixing element extends through the perforations in the aligned assembled state. Through this configuration, the arrangement of rods and spacer elements can be secured by the fixing element in relation to one another and effectively braced in circumferential direction.

According to a preferred embodiment, the slotted screen assembly is configured as a slotted screen cylinder or slotted screen basket, and the reinforcement element is configured as reinforcement ring for receiving radial loads. The spacer element provided in the invention determines either alone or in cooperation with the foot width of the rods reliably the gap width or the slot width of such a slotted screen cylinder, and all components can be reliably and securely interconnected, without material union.

In particular, the form-fitting connection of rods and reinforcement element is realized by a contouring which is dovetail-shaped, T-shaped, bulb-shaped, keyhole-shaped or combinations thereof or the like. According to the demands, a suitable contouring can be selected for the connection of rods and reinforcement elements, which should also be realized as far as possible without material union.

Preferably, the form-fitting connection between spacer element and reinforcement element is of embracing configuration. In this way, a reliable securement can be ensured in radial direction as well as in circumferential direction or in spatial distance of the rods, i.e. in gap width direction. Preferably, the form-fitting connection can be configured of dovetail shape whereby the dovetailed groove may, for example, be provided in the reinforcement element, and the spacer element and the rods can have the complementary projections. Of course, the configuration of the dovetailed, form-fitting connections may also be implemented vice versa.

In order to simplify assembly, several spacer elements may be united in the form of a single-piece spacer comb which, in turn, may include one or more spacer comb segments. In this way, there is no need to possibly line up individual spacer elements during assembly between the rods.

Preferably, such a spacer comb or the spacer comb segments thereof is connected with the reinforcement element of the slotted screen assembly by means of a clamped connection. Manufacturing tolerances can hereby be compensated and a slotted screen assembly can be realized which employs almost exclusive plug-in joining operation without material union, such as welding, soldering or the like.

Such a clamped connection can be implemented by suitably providing a clamping element, which is preferably configured in the form of a profiled clamping wire which can then be introduced and pressed in after pushing in the spacer element or the spacer comb or its segments in the existing intermediate space between the reinforcement element, spacer element and the associated rod for implementing the clamped connection.

In summary, it is essential in a slotted screen assembly according to the invention to be able to stock structural components of semi-finished products at smaller manufacturing depth to realize a cost-efficient manufacture of slotted screen assemblies. In order to realize a greatest possible variation of slotted screen assemblies while still enabling a cost-efficient manufacture, a slotted screen assembly according to the invention is configured and realized in the form of a modular system.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a fragmentary perspective view of a first preferred embodiment of a slotted screen assembly according of the invention;

FIGS. 2a to 2e show detailed perspective illustration of various exemplified embodiments of spacer elements for use in a slotted screen assembly according of the invention;

FIGS. 2f and 2g show schematic perspective illustrations of assembled components for a slotted screen assembly according of the invention;

FIG. 3 shows a fragmentary perspective view of a second embodiment of a slotted screen assembly according of the invention;

FIG. 4 shows a fragmentary perspective view of a third embodiment of a slotted screen assembly according of the invention, including a spacer element formed on a foot area of a rod;

FIG. 5a shows a detailed perspective view of a rod configured for application in the slotted screen assembly of FIG. 1;

FIGS. 5b and 5c show detailed perspective views of the rod show, equipped with exemplified embodiments of spacer elements,

FIG. 6a shows a perspective illustration of a spacer element in the form of a single-piece spacer comb, attached to a rod;

FIG. 6b shows a side view of the spacer comb, attached to the rod;

FIG. 7a shows a schematic perspective view of a spacer element in the form of a single-piece spacer comb for attachment to a rod, using a clamping element for making a clamped connection between the spacer comb or a spacer comb segment and a reinforcement element; and

FIG. 7b shows a top view of the illustration of FIG. 7a.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

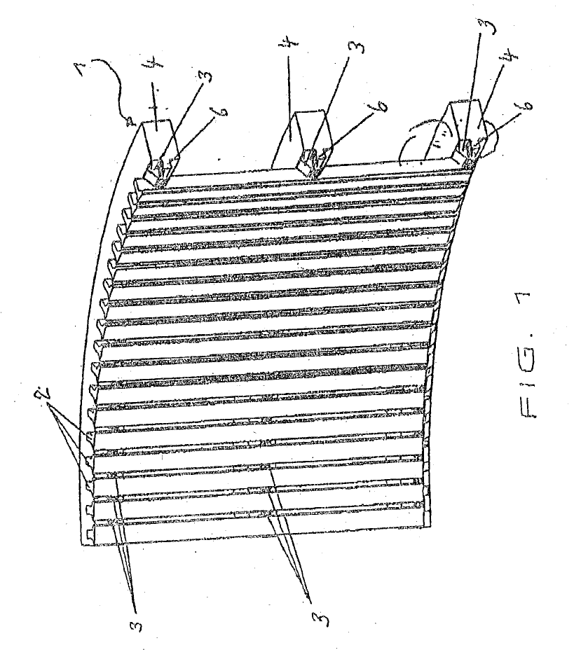

Turning now to the drawing, and in particular to FIG. 1, there is shown a fragmentary schematic perspective view of an exemplified embodiment of a slotted screen assembly, generally designated by reference numeral 1. The slotted screen assembly 1 has, for example, a cylindrical configuration and forms in its entirety a slotted screen basket or a slotted screen cylinder for treatment of fiber suspensions in the paper industry for sorting or the like.

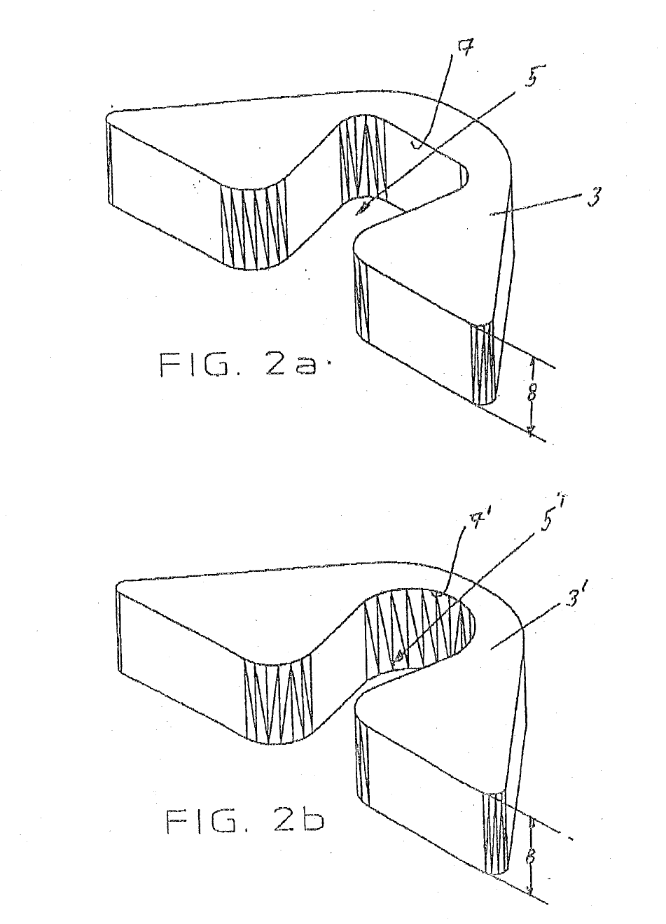

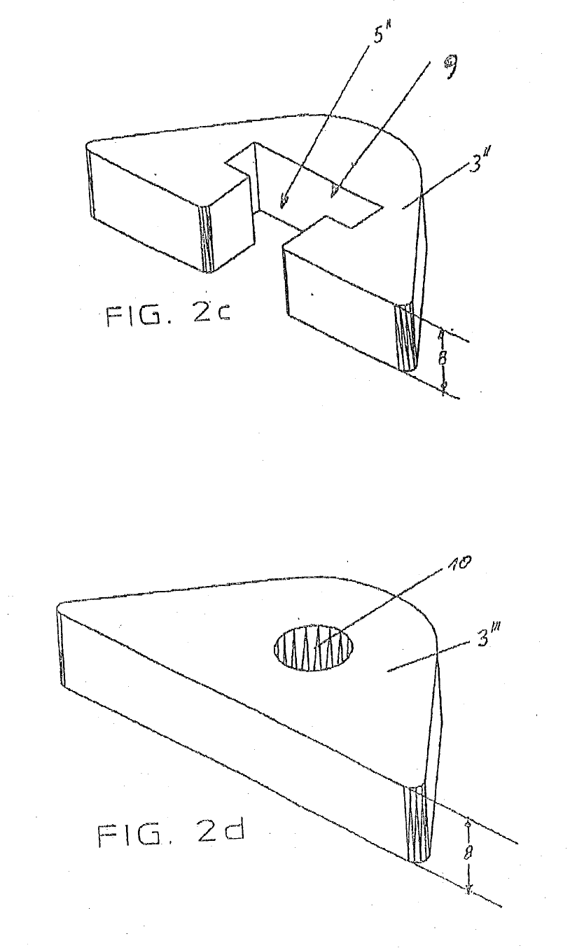

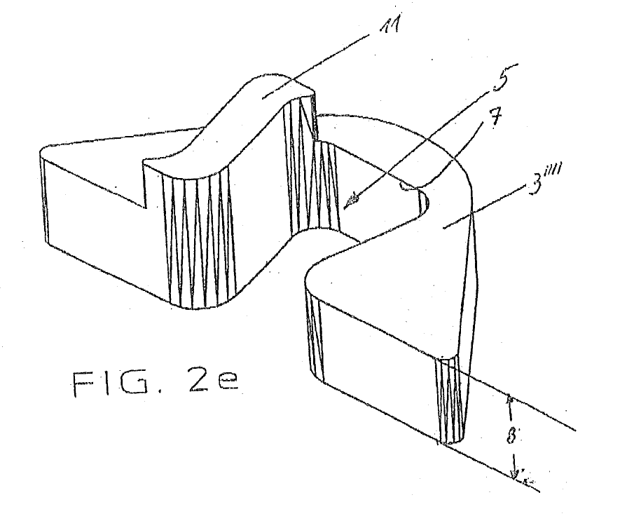

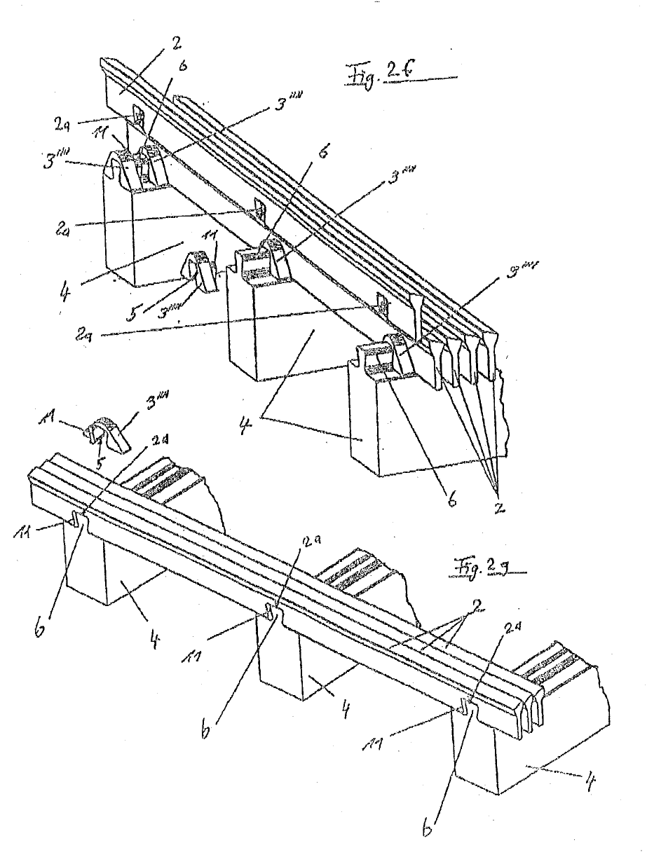

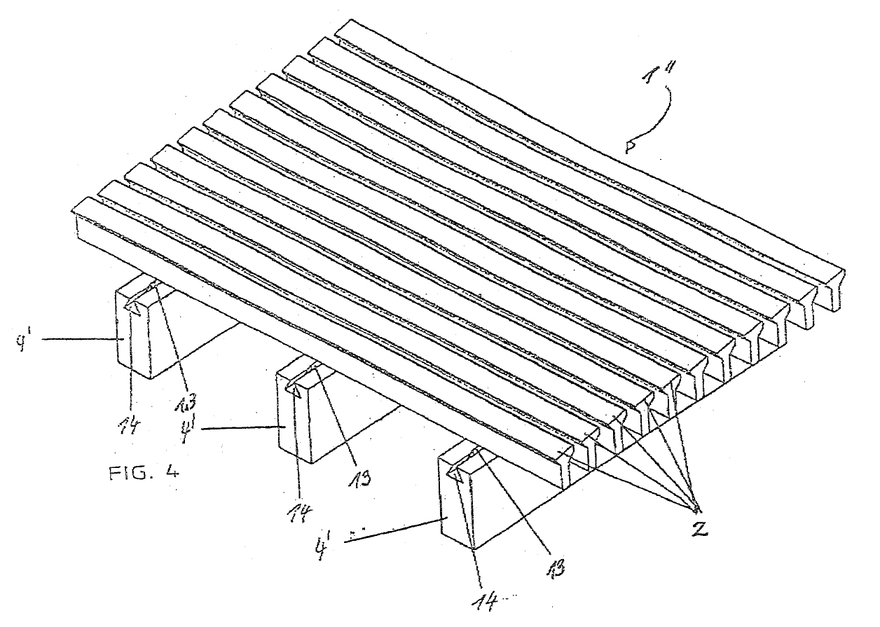

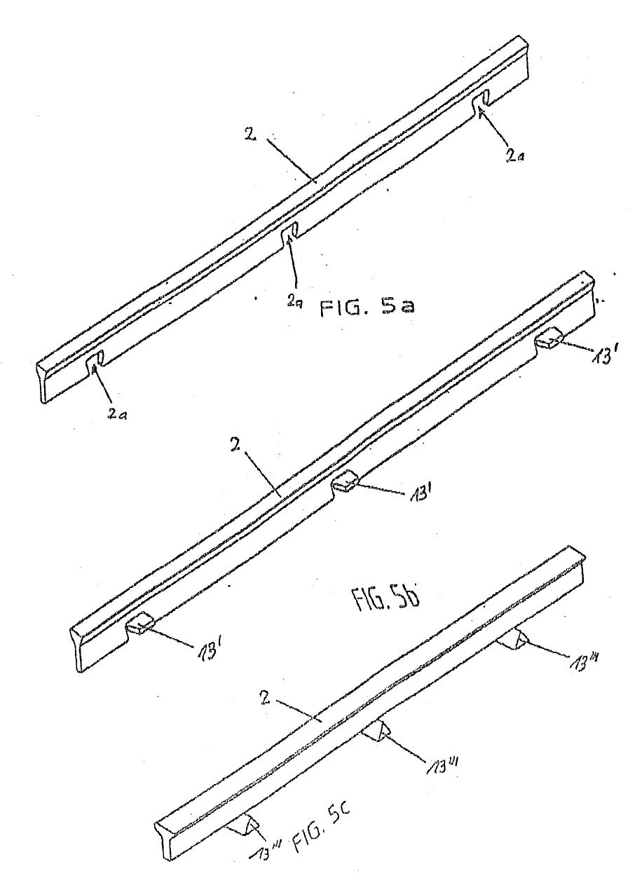

The slotted screen assembly 1 includes several rods 2, which may involve wire-like profiled rods and extend at a distance in circumferential direction and in parallel relationship in longitudinal direction. The distance determinative for the slot width between two neighboring rods 2 is governed with the assistance of a spacer element, designated with 3, between the neighboring rods 2. The slotted screen assembly 1 further includes several reinforcement elements 4 disposed in spaced-apart relationship in axial elongation of the slotted screen assembly 1 and configured in a slotted screen basket in circumferential direction preferably in the form of continuous reinforcement rings. Such a slotted screen assembly 1 of rods 2, spacer elements 3 and reinforcement elements 4 is kept in its predetermined arrangement by a form-fitting connection of rods 2 and/or the spacer element 3 and the reinforcement element 4. The rods 2 have a foot area provided with recesses 2a which are associated to the projection 6 of the reinforcement element 4, as shown in particular in FIGS. 2f and 2g as well as FIG. 5a.

FIG. 2a is a detailed perspective illustration of the spacer element 3, used, for example in FIG. 1 and shown here in more detail. Such a spacer element 3 has a recess 5 which receives, preferably in embracing relationship, a respective projection 6 of the reinforcement element 4. The opening width of the recess 5 of the spacer element 3 is preferably smaller than the dimensions of the base 7 of the recess 5. In this configuration of the slotted screen assembly 1, the thickness 8 of the spacer element 3 governs the predetermined but variable distance between the rods 2. This distance between the rods 3 can be varied by a respective selection of the thickness 8 of the spacer element 3. Spacer elements 3 with the respectively desired different thicknesses 8 can be pre-fabricated in large numbers in a cost-efficient manner and stocked. Depending on the desired application of the customer, a slotted screen assembly 1 of pre-fabricated components can be put together in a modular way, namely of rods 2, spacer elements 3 and reinforcement elements 4. In this embodiment of the slotted screen assembly 1, the rods 2 are lined up upon the respective reinforcement elements 4 for intermediate disposition of the respective spacer elements 3, whereby the spacer elements 3 form together with the reinforcement elements 4 a form-fitting connection, so that the overall arrangement of rods 2, spacer element 3 and reinforcement elements 4 is securely held together in a reliable and safe manner. As the end surfaces of the spacer elements 3 can be easily finished, without any difficult, in an extremely precise manner, for example through grinding, for attachment to the side surfaces of the rods 2, the distances can be evenly maintained in circumferential direction in a predetermined extent by the spacer elements 3 between the rods 2 of the slotted screen assembly 1 solely by the joining of the components of the modular system, without requiring a material union, such as welded connections or the like. Thus, slotted screen assemblies can easily be made with different gap widths, as governed by the spacer elements 3, during configuration according to the invention, and it is only necessary to provide spacer elements 3 which are different in thickness. The rods 2 and the reinforcement elements 4 can be uniformly designed, and no modification thereof is necessary, in the event slotted screen assemblies 1 of different slot widths between the rods 2 should be made. In this way, the manufacture of the reinforcement elements 4 and the rods 2 is simplified, as they can be made in mass production as pre-fabricated components in unchanged configuration.

Different embodiments of spacer elements 3 are shown in more detail with reference to FIGS. 2a to 2e and described in the following.

The spacer element 3 shown in FIG. 2a, employed, for example, in the slotted screen assembly of FIG. 1, includes—as already described—a recess 5 of dovetail shape and an essentially flat base surface 7. In direction of elongation of the recess 5, the base surface 7 is of greater dimension than the opening formed between the legs of the recess 5. Such a recess 5 embraces thus the respectively complementary projection 6 of the reinforcement element 4 in a form-fitting manner to realize an inner union of the slotted screen assembly 1.

FIG. 2b shows a spacer element 3′ which differs from FIG. 2a by the provision of a recess 5′ which has a rounded base area 7′.

FIG. 2c shows a spacer element 3″ in which the recess 5″ has a type of undercut region 9 for providing the form-fitting connection with a respectively complementary projection 6 of the reinforcement element 4. Also in this case, the undercut region 9 at the base of the recess 5″ has a greater size than the opening area of the recess 5″.

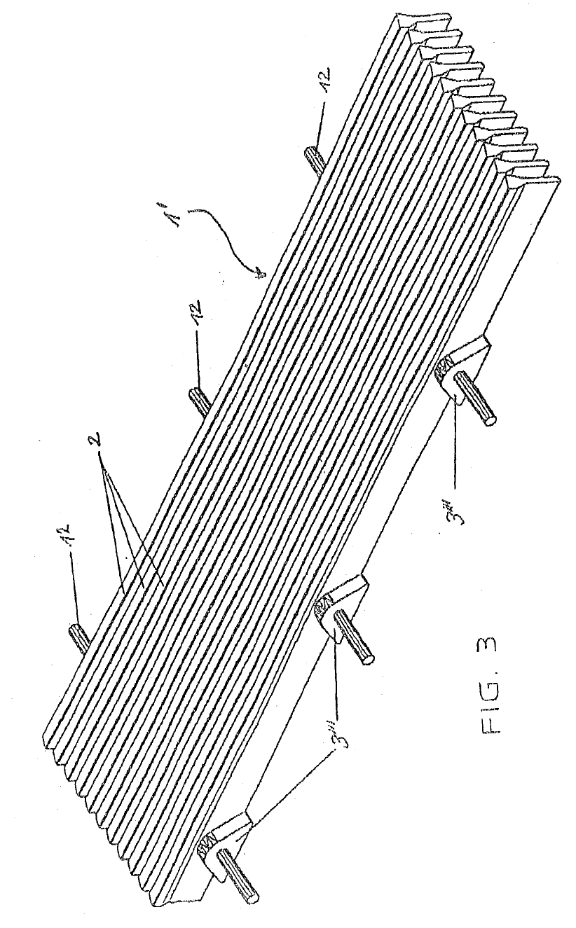

FIG. 2d shows a spacer element 3′″ which is provided solely with a through opening 10 in the direction of thickness of the spacer element 3′″. This spacer element 3′″ will be explained in more detail with reference to a further preferred embodiment of a slotted screen assembly according to the invention, in particular with reference to FIG. 3.

FIG. 2e shows a spacer element 3″″ which has a base configuration in conjunction with the recess 5 in correspondence to the one of the spacer element of FIG. 2a. This spacer element 3″″ has in addition a projection 11 jutting out in vertical direction from the spacer element 3″″. This projection 11 is provided on the spacer element 3″″ in FIG. 2e upon the boundary side of the recess 5. As shown in the assembled illustrations of FIGS. 2f and 2g, using a spacer element 3″″, in this embodiment the recess 12a of rod 2, complementing the projection 6 of the reinforcement element 4, can be greater than the projection 6. In particular, the configuration can be effected when the width of the projection 6 of the reinforcement element 4 on the head side is smaller than the narrowest area of the recess 2a of the rod 2, so that the rod 2 can be placed upon in vertical direction with respect to the projection 6 to realize a simplification of the assembly. The projection 11 upon the spacer element 3′″ according to FIG. 2e closes the remaining intermediate space between the recess 2a of the rod 2 and the projection 11 of the spacer element 4 in a substantially form-fitting manner and thus serves at the same time as lock element, i.e. the spacer element 3″″ assumes in addition a locking function between the reinforcement element 4 and the rod 2. The projection 11 engages in a form-fitting manner for implementing a clamping and/or locking function in the intermediate space between the projection 11 and the respectively designed recess 2a in rod 2 so as to reliably hold together the spacer elements 3′″, reinforcement element 4 and rods 2, when ultimately being assembled, whereby the spacer element 3″″ assumes the locking function of the form-fitting connection between rod 2 and reinforcement element 4.

FIG. 3 depicts a schematic perspective view of a variation of the slotted screen assembly 1′. Hereby, spacer elements 3′ according to FIG. 2d are employed, which have each a through opening 10. In this embodiment, also the rods 2 have through openings with respectively associated alignment, wherein a wire-shaped fixing element 12 extends through these through openings, when the through openings 10 and the through openings of the rods 2 are in alignment, to secure the association of the spacer elements 3′″ and the rods 2 for maintaining a predetermined distance between the rods 2 thanks to the spacer elements 3′″. Therefore, the arrangement of rods 2 and spacer elements 3′″ is fixed independently from the configuration of the reinforcement element 4 in a predetermined way thanks to the fixing element 12. Of course, such a fixing element 12 may be provided, in addition to the afore-described variation, also with the spacer elements 3, 3′, 3″ and 3″″, shown in FIGS. 2a to 2c and 2e.

FIG. 4 shows a schematic perspective view of a further embodiment of a slotted screen assembly 1″. In this configuration, a spacer element 13 is formed on the foot of the respective rod 2 and has a dovetail shape for form-fitting engagement in an associated recess 14 of a reinforcement element 4′. With the assistance of this spacer element 13, formed on the foot of the respective rods 2, the predetermined distance to the respectively neighboring rod 2 is maintained for determination of the respectively desired slot width therebetween and a form-fitting connection is produced with the reinforcement element 4′ via this spacer element 13 formed on the rod 2.

FIG. 5a shows a detailed view of a rod 2 which, for example, is used in the embodiments of the slotted screen basket 1 as well as in a configuration according to the FIGS. 2e to 2g. The rod 2 is provided in lengthwise extension with spaced-apart recesses 2a which are assigned to the projection 6 of the respective reinforcement elements 4.

FIGS. 5b and 5c show variations of spacer elements 13 which are formed of same material at the foot of the rods 2 and effect a form-fitting interaction with a reinforcement element, not shown in more detail. In the configuration of FIG. 5b, the spacer element 13′ is provided at the foot of the rod 2 by being punched out and bent outwards. The spacer element 13′ projects hereby out from the side surface of the rod 2 in proximity of the foot region in a vertical direction and determines the slot width of the respective slotted screen assembly. FIG. 5c shows the provision of a spacer element 13′″ arranged on the end surface of the foot of the rod 2 and having a triangular cross section as variation to FIG. 5b, whereby the triangle tip is connected with the foot region of the associated rod 2. Also in this case a configuration is thus involved in which the spacer element 13′″ is provided directly at the foot of the respective rod 2 and does not constitute a separate component as opposed to the previously described embodiments. Rather, the spacer elements 13 to 13′″, according to the embodiments of FIGS. 4 to 5c, form a unitary structure with the respective rod 2, so that a respective slotted screen assembly is formed in its entirety by a modular system comprised of two elements only, namely rods 2 with spacer elements 13 to 13′″ and respectively associated reinforcement elements 4′. As a consequence, the small number of components simplifies the assembly of the coupled slotted screen assembly 1.

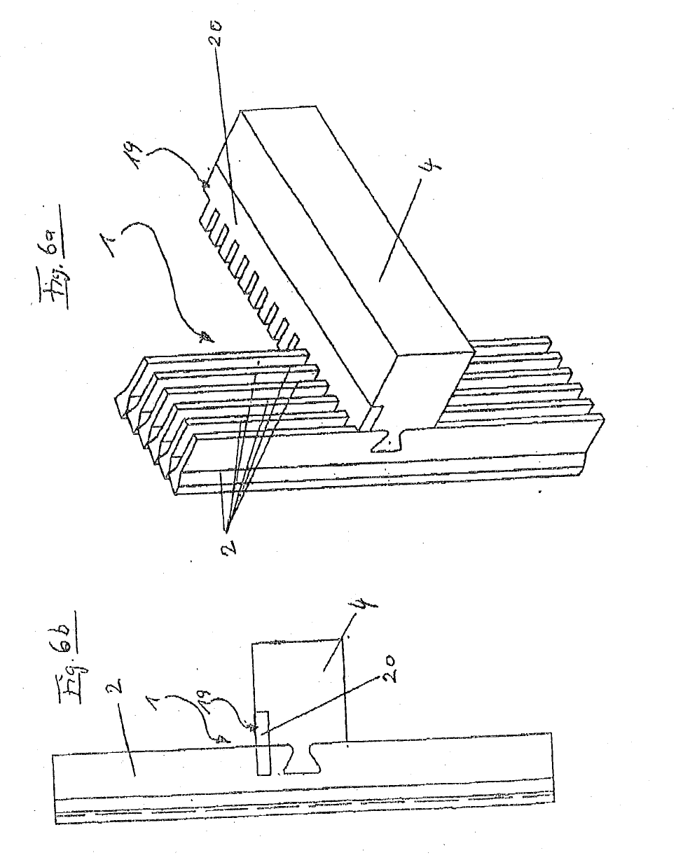

Referring to FIGS. 6a and 6b, there are shown a further variation of a slotted screen assembly 1. In this embodiment, a reinforcement element 4 is connected with the respective rods 2 by means of a form-fitting joint in the form of a dovetailed connection. The spacer element 19 in FIG. 6a is configured as spacer comb 20 which may possibly include one or more spacer comb segments for providing a complete slotted screen assembly 1, wherein the spacer comb 20 or the spacer comb segments include several spacer elements interconnected in one piece. Such a single-piece spacer comb 20 or respective spacer comb segments simplifies the assembly by assuming the spacer function for the rods 2 by means of a component that can be uniformly handled. This spacer comb 20 or the respective spacer comb segments are then braced with the assistance of the reinforcement element 4 in fully assembled state such that the rods 2 are disposed in parallel spaced-apart relationship while the predetermined gap width is maintained.

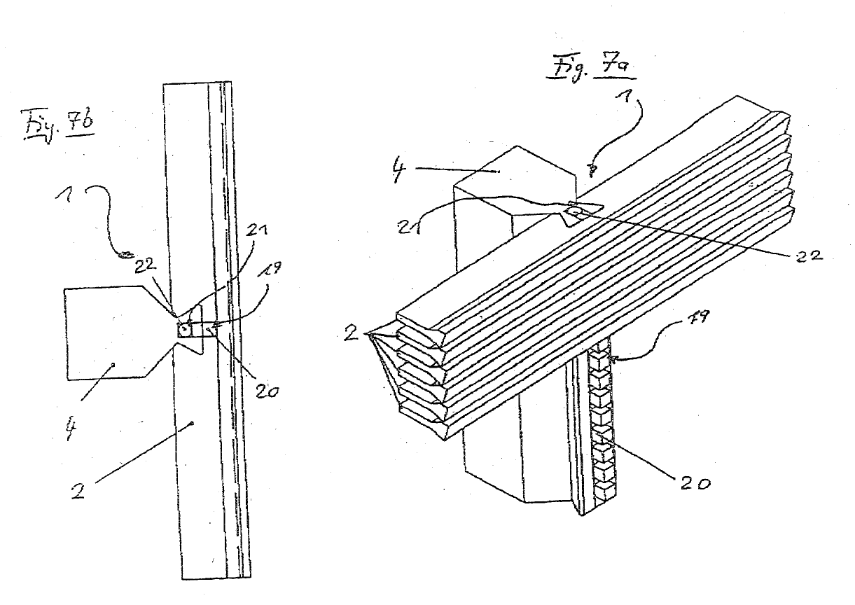

Referring to FIGS. 7a and 7b, there are shown a further variation of a slotted screen assembly 1 in conjunction with a reinforcement element 4 and a spacer comb 20 as spacer element. In this configuration, the reinforcement element 4 is connected through a form-fitting connection with the associated slot(s) 2—similar as illustrated in the previous preferred embodiments—and the spacer comb 20 or the respective spacer comb segments thereof are placed in a respective recess in the reinforcement element 4 at coarse tolerance. In order to realize a stable joint of reinforcement element 4, rods 2 and spacer comb 20, there is additionally provided, for providing a clamped connection, a clamping element 21 which is configured in the depicted preferred embodiment, in particular in the form of a profiled clamping wire 22. After arrangement of reinforcement element 4, rods 2 and the spacer comb 20 or the spacer comb segments, the clamping element 21 is installed to provide a form-fitting and forced engagement of the entire jointed assembly for formation of a coupled slotted screen assembly. In this configuration, there is no need to conform the tolerances of the spacer comb 20 as precisely to the other elements of the slotted screen assembly 1, rather with the assistance of the clamping element 21, all tolerances of the coupled slotted screen assembly 1 are compensated, and the respectively joined parts are then mutually fully braced with the assistance of the clamping element 21. In this preferred embodiment, the clamping element 21 assumes a lock-like function for the jointed connection of the individual elements of the slotted screen arrangement 1.

Although not shown in more detail, the slotted screen assembly 1 may, of course, also include combinations of the afore-described variations of spacer elements 3 to 3″″ and/or 13 to 13′″. The invention is thus not limited to the afore-explained and described details of the slotted screen assembly 1, but numerous changes and modifications are possible, that are available to the artisan if needed, without departing form the spirit of the invention. Of course, there is no need to configure the slotted screen assembly 1 in the form of a slotted screen basket of cylindrical shape, but the slotted screen assembly may also be provided as planar structure in the configuration according to the invention in the form of a slotted screen mat.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A slotted screen assembly, in particular for treatment of fiber suspensions in the paper industry, comprising:
at least one reinforcement element;
a plurality of rods extending in predetermined spaced-apart parallel relationship and fixed to the at least one reinforcement element; and
a spacer element for adjusting a distance between neighboring rods upon the reinforcement element to thereby define a gap width of the slotted screen assembly, thereby maintaining a relative position between the rods at a distance which is variable, wherein at least one of the rods and the spacer element form a form-fitting connection with the reinforcement element.

2. The slotted screen assembly of claim 1, wherein the spacer element is configured for implementing the clamped form-fitting connection between the rod and the reinforcement element.

3. The slotted screen assembly of claim 1, wherein the spacer element has a thickness which defines the gap width.

4. The slotted screen assembly of claim 1, wherein the rods are defined by a foot width, wherein an interaction of the foot width of the rods and the spacer element defines the gap width.

5. The slotted screen assembly of claim 1, wherein the spacer element is formed on the rods.

6. The slotted screen assembly of claim 1, wherein the spacer element is a separate component disposed between the rods and connected in form-fitting manner with the reinforcement element.

7. The slotted screen assembly of claim 6, wherein one member selected from the group consisting of the spacer element and the reinforcement element is provided with a recess, and wherein the other member of the group is provided with a complementary projection for providing the form-fitting connection.

8. The slotted screen assembly of claim 7, wherein the recess has a base and an opening area, wherein a width of the base is greater than a width of the opening region.

9. The slotted screen assembly of claim 1, wherein the spacer element has a flow-confronting outer contour of a shape which enhances the flow dynamics.

10. The slotted screen assembly of claim 1, wherein the spacer element has areas which face the reinforcement element and conform without transition to a contour of the reinforcement element.

11. The slotted screen assembly of claim 1, wherein the spacer element has a substantially triangular configuration.

12. The slotted screen assembly of claim 1, wherein the spacer element is grinded to a desired thickness.

13. The slotted screen assembly of claim 1, wherein the rods and the spacer element have corresponding perforations, and further comprising a wire-like fixing element extending through the perforations, when the perforations are aligned.

14. The slotted screen assembly of claim 1, configured as slotted screen cylinder, wherein the reinforcement element is configured as reinforcement ring for receiving radial loads.

15. The slotted screen assembly of claim 1, wherein the rods and the reinforcement element are contoured in a configuration selected from the group consisting of dovetail-shape, T-shape, bulb-shape, keyhole-shape, and combinations thereof, to realize the form-fitting connection.

16. The slotted screen assembly of claim 7, wherein the recess embraces the projection to provide the form-fitting connection.

17. The slotted screen assembly of claim 16, wherein the form-fitting connection has a dovetail configuration.

18. The slotted screen assembly of claim 1, wherein the spacer element is configured in the form of a single-piece spacer comb which has one or more spacer comb segments.

19. The slotted screen assembly of claim 18, wherein the spacer comb is connected with the reinforcement element by means of a clamped connection.

20. The slotted screen assembly of claim 19, wherein the clamped connection includes a clamping element of particular profile.

21. The slotted screen assembly of claim 19, wherein the clamping element is constructed in the form of a clamping wire.

22. A modular screen assembly, comprising:
a support element;
a plurality of rods attached to the support element in spaced-apart parallel relationship; and
a plurality of spacer elements of varying thickness to allow adjustment of a relative position between the rods upon the support element at a desired distance and to thereby define a gap of the slotted screen assembly, wherein at least one of the rods and the spacer element form a form-fitting connection with the reinforcement element.
